(19) United States
(12) Patent Application Publication
(10) Pub. No.: US 2007/0243768 A1
(43) Pub. Date: Oct. 18, 2007

(54) Lamp holder device

(76) Inventor: Chin-Sheng Teng, San Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/602,224

(22) Filed: Nov. 21, 2006

(30) Foreign Application Priority Data
Apr. 13, 2006 (CN) 200620013580.9

(51) Int. Cl. H01R 33/00

(52) U.S. Cl. 439/641

(57) ABSTRACT

A lamp holder device includes a lamp holder, a connecting pipe, and a lamp holder sleeve, the connecting pipe is connected electronically with the lamp holder, the material of the lamp holder sleeve is plastic, the lamp holder has a setting portion, an accommodating structure is set in the lamp holder sleeve corresponding to the setting portion to fix the lamp holder into the lamp holder sleeve, the connecting pipe is connected with the lamp holder sleeve by a screw thread. A inside screw thread and a outside screw thread are set on the inside wall and outside wall of the lamp holder sleeve respectively, the lamp holder can be lock in the lamp holder sleeve because of the plastic has elasticity, the assembling by the screw thread is simple and convenient, and the cost of such plastic is low.

### BACKGROUND OF THE INVENTION

1. Field of the Invention

The present invention relates to a lamp holder device, and more especially to a lamp holder device having a sleeve.

2. Description of the Prior Art

At present, a lamp holder device includes a lamp holder and a lamp holder sleeve, the materiel of the lamp holder sleeve is metal or pottery, an elastic piece is set in the lamp holder sleeve to fix the lamp holder in the lamp holder sleeve or to cooperate with a lampshade by a tooth-like structure.

Because the material of the lamp holder sleeve is metal or pottery, so the cost is high, and the inside structure of the lamp holder sleeve is complicated, which makes high request on the arts and crafts, and assembling is inconvenient. Moreover, the material of pottery is easy to be broken into pieces, which makes high cost of the usage of the lamp holder, and replacing is inconvenient also.

Hence, the inventors of the present invention believe that these shortcomings above are able to be improved upon and finally suggest the present invention which is of a reasonable design and is an effective improvement based on deep research and thought.

### SUMMARY OF THE INVENTION

An object of the present invention is to provide a lamp holder device, assembling of the lamp holder device is convenient, and the device's cost is low.

To achieve the above-mentioned object, the lamp holder device in accordance with the present invention is disclosed. The lamp holder device has a lamp holder, a connecting pipe, and a lamp holder sleeve, the connecting pipe is connected electronically with the lamp holder, the material of the lamp holder sleeve is plastic, the lamp holder has a setting portion, an accommodating structure is set in the lamp holder sleeve corresponding to the setting portion to fix the lamp holder into the lamp holder sleeve, the connecting pipe is connected with the lamp holder sleeve by screw thread.

Advantages of the lamp holder device of the present invention are: the material of the lamp holder sleeve is plastic, the cost of such plastic is low, and moreover, assembling by screw thread is simple and convenient.

To further understand features and technical contents of the present invention please refer to the following detailed description and drawings related the present invention. However, the drawings are only to be used as references and explanations, not to limit the present invention.

### BRIEF DESCRIPTION OF THE DRAWINGS

FIG. 1 is an exploded isometric view of a first embodiment of the present invention;

FIG. 2 is an assembled isometric view of the first embodiment of the present invention;

FIG. 3 is an exploded isometric view of a second embodiment of the present invention;

FIG. 4 is a cutaway isometric view of the second embodiment of the present invention;

FIG. 5 is an assembled isometric view of the second embodiment of the present invention;

FIG. 6 is an assembled way view of the second embodiment of the present invention;

FIG. 7 is a cutaway isometric view of the first embodiment of the present invention, in which, the lamp holder sleeve is set in the fixing hole;

FIG. 8 is a cutaway isometric view of the second embodiment of the present invention, in which, the lamp holder sleeve is set in the fixing hole;

FIG. 9 is a cutaway isometric view of the third embodiment of the present invention, in which, the lamp holder sleeve is set in the fixing hole.

### DETAILED DESCRIPTION OF PREFERRED EMBODIMENTS

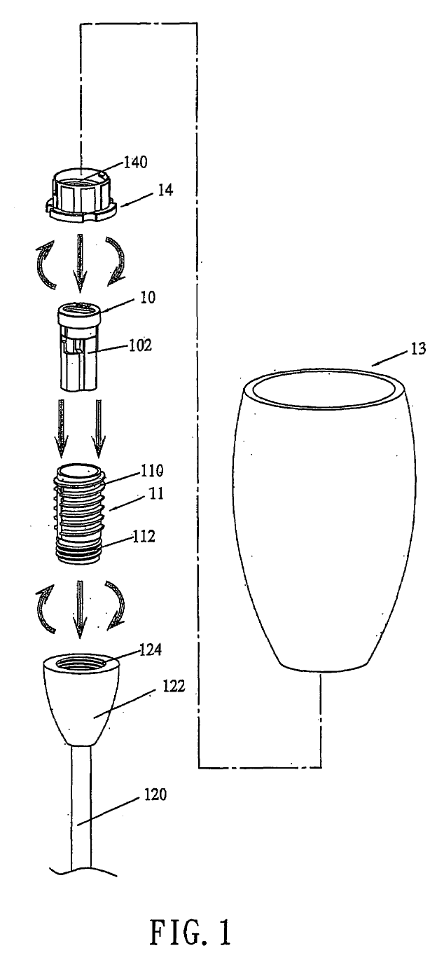

Referring to FIG. 1, an exploded isometric view of a lamp holder device of a first embodiment of the present invention is shown. The lamp holder device includes a lamp holder 10, a lamp holder sleeve 11, a lamp holder base 122, a lampshade 13 and a lampshade base 14. The lamp holder 10 includes a setting portion 102. The lamp holder sleeve 11 is barrel-shaped, and the material of the lamp holder sleeve 11 is plastic, such as PVC (Polyvinylchloride), and so on. An accommodating structure (not be shown) is set in the lamp holder sleeve 11 corresponding to the setting portion 102 to fix the lamp holder 10 into the lamp holder sleeve 11. A first outside screw thread 110 and a second outside screw thread 112 are set on the outside wall of the lamp holder sleeve 11, a lock block (not be shown) is set on the inside wall of the lamp holder sleeve 11 to lock the setting portion 102, a connecting pipe 120 is set below the lamp holder base 122, a electronic connecting device (not be shown) is set in the connecting pipe 120, the lamp holder base 122 is a coniform sleeve, and a first inside screw thread 124 is set on the inside wall of the lamp holder base 122, the first inside screw thread 124 is joggled with the second outside screw thread 112 of the lamp holder sleeve 11. The material of the lampshade 13 is photic, and two openings are set at two ends of the lampshade 13 respectively thereof, the lampshade base 14 is column-shaped, a second inside screw thread 140 is set on the inside wall of the lampshade base 14, the second inside screw thread 140 is joggled with the first outside screw thread 110.

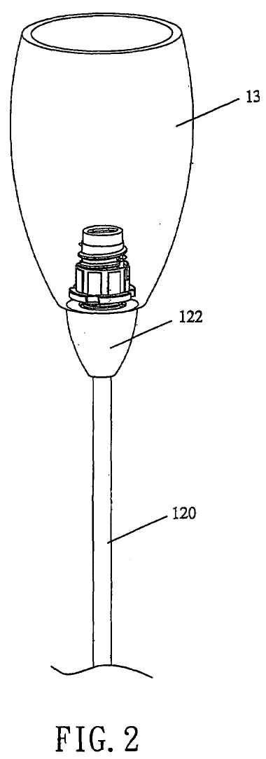

Referring to FIG. 1 and FIG. 2, an assembled isometric view of the first embodiment of the present invention is shown, the process of assembling is: lock the lamp holder 10 into the lamp holder sleeve 11, and then revolve the lamp holder sleeve 11 which holds the lamp holder 10 into the lamp holder base 122, and then cover the lampshade 13 at the top of the lamp holder base 122 to joint the bottom of the lampshade 13 with the top of the lamp holder base 122, finally, revolve the lampshade base 14 to the first outside screw thread 110 of the lamp holder sleeve 11 to fix the lampshade 13 completely onto the lamp holder base 122, in this way, the process of assembling the first embodiment of the present invention is accomplish.

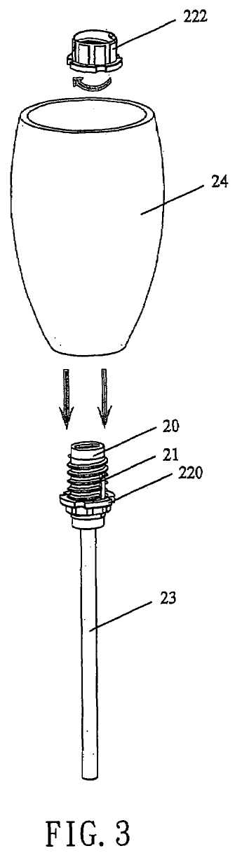

Referring to FIG. 3, an exploded isometric view of a second embodiment of the present invention is shown. The lamp holder device includes a lamp holder 20, a lamp holder sleeve 21, a connecting pipe 23, a first lampshade base 220 and a second lampshade base 222. The lamp holder sleeve 21 is barrel-shaped, and the material of the lamp holder sleeve 21 is plastic, such as PVC (Polyvinylchloride), and so on.

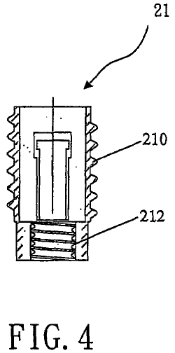

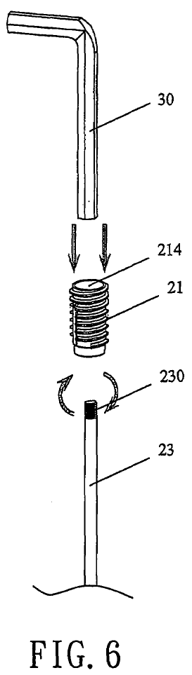

Referring to FIG. 3 and FIG. 4, a cutaway isometric view of the second embodiment of the present invention is shown. A third outside screw thread 210 is set on the outside wall of the lamp holder sleeve 21, a lock block (not be shown) is set on the inside wall of the lamp holder sleeve 21 to lock the lamp holder 20, a forth inside screw thread 212 is set on the lower inside wall of the lamp holder sleeve 21, a forth outside screw thread 230 (referring to FIG. 6) is set on the upper outside wall of the connecting pipe 23, the forth outside screw thread 230 is joggled with the forth inside screw thread 212 of the lamp holder sleeve 21. Electric conduction material is set on the top of the connecting pipe 23, the first lampshade base 220 and the second lampshade base 222 are all column shape, a fifth inside screw thread and a sixth inside screw thread (not be labeled) are set on the inside walls of the first lampshade base 220 and the second lampshade base 222 respectively to joggle with a third outside screw thread 210 of the lamp holder sleeve 21.

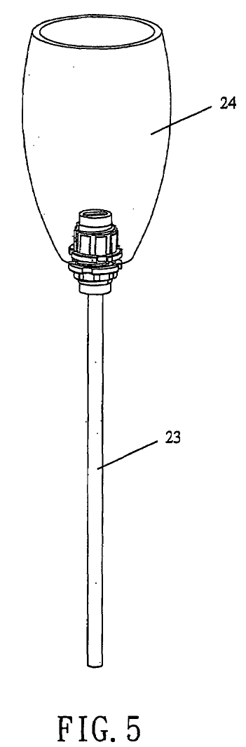

Referring to FIG. 3 and FIG. 5, an assembled isometric view of the second embodiment of the present invention is shown. The process of assembling is: lock the lamp holder 20 into the lamp holder sleeve 21, and then revolve the lamp holder sleeve 21 which holds the lamp holder 20 onto the connecting pipe 23, and then revolve the first lampshade base 220 to the bottom of the lamp holder sleeve 21, and then cover the lampshade 24 to joint the bottom of the lampshade 24 with the top of the first lampshade base 220, finally, revolve the lampshade base 222 to the upper of the lamp holder sleeve 21 to fix the lampshade 24 completely, in this way, the process of assembling the first embodiment of the present invention is accomplish.

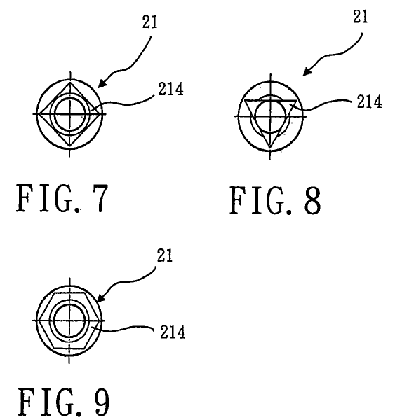

Referring to FIG. 4 and FIG. 6, an assembled way view of the second embodiment of the present invention is shown. The present invention also includes a fixing device 30, and the fixing device 30 which is bended to shape an angle is long and narrow. A fixing hole 214 is set upon the forth inside screw thread 212 in the lamp holder sleeve 21 corresponding to the fixing device 30, the figure of the inside wall of the fixing hole 214 is corresponding to the figure of the outside wall of the fixing device 30, when be put into the lamp holder sleeve 21, the fixing hole 214 may fix the fixing device 30 to revolve the lamp holder sleeve 21 onto the connecting pipe 23. Referring to FIG. 7, FIG. 8 and FIG. 9, cutaway isometric views of which the lamp holder sleeve 21 be put into the fixing hole 214 are shown. Shape of the fixing hole 214 is triangle, quadrangle or hexagon. Referring to FIG. 6 accordingly, the figure of the inside wall of the fixing hole 214 is inosculate with the figure of the outside wall of the fixing device 30. Which can be understood is that the fixing hole 214 and the fixing device 30 are applicable to the first embodiment of the present invention.

The present invention makes an effort to bring about various improvements to a well-known lamp holders device being used widely, and the material of the lamp holder is plastic, so the cost is low.

What is disclosed above is only the preferred embodiment of the present invention, and therefore it is intended that the present invention not be limited to the particular embodiment disclosed. It should be understood by those skilled in the art that various equivalent changes may be made depending on the specification and the drawings of present invention without departing from the scope of the present invention.

What is claimed is:

1. A lamp holder device; comprising:
a lamp holder;
a connecting pipe; and
a lamp holder sleeve;
wherein the connecting pipe is connected with the lamp holder electronically, the material of the lamp holder sleeve is plastic, the lamp holder defines a setting portion, an accommodating structure is set in the lamp holder sleeve corresponding to the setting portion to fix the lamp holder into the lamp holder sleeve, and the connecting pipe is connected with the lamp holder sleeve by a screw thread.

2. The lamp holder device as claimed in claim 1, wherein a lock block is set on the inside wall of the lamp holder sleeve to lock the setting portion of the lamp holder.

3. The lamp holder device as claimed in claim 1, wherein a first outside screw thread and a second outside screw thread are set on the outside wall of the lamp holder sleeve.

4. The lamp holder device as claimed in claim 3, wherein the connecting pipe defines a lamp holder base on the top thereof, a first inside screw thread is set on the inside wall of the lamp holder base, the first inside screw thread is joggled with the second outside screw thread of the lamp holder sleeve.

5. The lamp holder device as claimed in claim 3, wherein the lamp holder further has a lampshade and a lampshade base, the material of the lampshade is photic, a second inside screw thread is set on the inside wall of the lampshade base, the second inside screw thread is joggled with the first outside screw thread.

6. The lamp holder device as claimed in claim 1, wherein a third outside screw thread is set on the outside wall of the lamp holder sleeve, a forth inside screw thread is set on the lower inside wall of the lamp holder sleeve.

7. The lamp holder device as claimed in claim 6, wherein a forth outside screw thread is set on the upper outside wall of the connecting pipe, the forth outside screw thread is joggled with the forth inside screw thread of the lamp holder sleeve.

8. The lamp holder device as claimed in claim 6, wherein the lamp holder device further has a lampshade, a first lampshade base and a second lampshade base, the material of the lampshade is photic, the first lampshade base and the second lampshade base are all column shape, a fifth inside screw thread and a sixth inside screw thread are set on the inside walls of the first lampshade base and the second lampshade base respectively to joggle with a third outside screw thread of the lamp holder sleeve.

9. The lamp holder device as claimed in claim 1, wherein the lamp holder device further has a fixing device, the fixing device is long and narrow and is bended to shape an angle.

10. The lamp holder device as claimed in claim 9, wherein a fixing hole is set in the lamp holder sleeve, the figure of the inside wall of the fixing hole is corresponding to the figure of the outside wall of the fixing device.
